(19) United States
(12) Patent Application Publication
(10) Pub. No.: US 2026/0171440 A1
(43) Pub. Date: Jun. 18, 2026

(54) WATER TRAP APPARATUS FOR FUEL CELLS AND METHOD OF CONTROLLING THE SAME

(71) Applicants: Hyundai Motor Company, Seoul (KR); Kia Corporation, Seoul (KR)

(72) Inventors: Hee Won Koo, Hwaseong-Si (KR); Seon Yong Lee, Hwaseong-Si (KR); Jae Kwan Bae, Seoul (KR)

(21) Appl. No.: 19/316,745

(22) Filed: Sep. 2, 2025

(30) Foreign Application Priority Data
Dec. 18, 2024 (KR) 10-2024-0189366

(51) Int. Cl. H01M 8/04119; H01M 8/04223; H01M 8/04225; H01M 8/0432; H01M 8/04537; H01M 8/04746

(52) U.S. Cl. CPC H01M 8/04156; H01M 8/04225; H01M 8/04253; H01M 8/04358; H01M 8/04559; H01M 8/04649; H01M 8/04761

(57) ABSTRACT

A water trap apparatus for fuel cells includes magnetic bodies, such as magnets or electromagnets, mounted opposite to each other at inlets of a water trap (into which hydrogen, water, and oxygen flow) and an outlet of the water trap (from which the hydrogen is discharged to be recirculated to a stack). Force from a magnetic field formed by the magnetic bodies acts on oxygen molecules in the same direction as the direction of the magnetic field and force due to another magnetic field formed by the magnetic bodies acts on water molecules in the direction opposite to the direction of the magnetic field, so as to prevent the water and the oxygen from being recirculated to the stack and to allow the water and the oxygen to be captured in the water trap.

### CROSS-REFERENCE TO RELATED APPLICATION

This application claims under 35 U.S.C. § 119(a) the benefit of priority from Korean Patent Application No. 10-2024-0189366 filed on Dec. 18, 2024, the entire contents of which are incorporated herein by reference.

### TECHNICAL FIELD

The present disclosure relates to a water trap apparatus for fuel cells and a method of controlling the same. More particularly, it relates to a water trap apparatus for fuel cells that may easily separate water and oxygen from recirculated hydrogen using magnetic bodies mounted in a water trap, and a method of controlling the water trap apparatus.

### BACKGROUND

A fuel cell system (e.g., of a vehicle) includes a fuel cell stack that generates electrical energy, a fuel supply system that supplies fuel (e.g., hydrogen) to the fuel cell stack and an air/oxygen supply system that supplies oxygen (e.g., in the air) to the fuel cell stack. The oxygen acts an oxidizer to the hydrogen in an electrochemical reaction in the fuel cell stack to produce energy.

The hydrogen and oxygen are supplied, respectively, to an anode and a cathode of the fuel cell stack. Protons and electrons are generated by an oxidation reaction of hydrogen at the anode, with water produced as a reaction byproduct. The generated protons and electrons move to the anode and cathode, respectively, through a polymer electrolyte membrane. The electrochemical reaction produces electrical energy, and as a result, the electrical energy may be charged to a battery or supplied to an electric load, such as a motor.

During operation of such a fuel cell stack (shortened to “stack” hereinafter), water produced in the stack as a byproduct of the electrochemical reaction may interfere with the flow of oxygen and hydrogen. Thus it is beneficial to remove the water from the stack. Often, the generated water is removed by allowing it to fall down in the stack due to gravity to be collected in a water trap.

FIG. 1 is a schematic diagram showing a water trap apparatus.

As shown in FIG. 1, if hydrogen is supplied to an anode of a stack 10, and unreacted hydrogen is discharged from the outlet of the anode of the stack 10 to a water trap 20, water (water in gaseous and liquid states) and a small amount of oxygen that crosses over from a cathode to the anode of the stack 10 are mixed and discharged to the water trap 20.

Subsequently, the water flowing into the water trap 20 falls to the bottom of the water trap 20 due to gravity and is collected, and hydrogen separated from the water is recirculated to the anode of the stack 10 along a recirculation line 22 by driving a recirculation blower 30 or discharged to the outside via a purge line 24.

If a certain amount or more of water is accumulated in the water trap 20, a drain valve 26 mounted on the bottom of the water trap 20 is opened under the control of a controller based on a signal from a water level detection sensor, thereby allowing the accumulated water to be discharged to the outside.

However, the water trap apparatus of FIG. 1 may experience at least the following problems.

First, because water and hydrogen flowing into the water trap 20 are not completely separated from each other, water may be recirculated to the stack with the hydrogen recirculated to the stack 10 along the recirculation line 22. The recirculated water may cause a local flooding phenomenon within the stack 10, power generation efficiency of the stack 10 may decrease due to the flooding phenomenon, and furthermore, deterioration of unit cells forming the stack 10 may be accelerated, which may result in deterioration in durability of the stack 10.

Second, the small amount of oxygen flowing into the water trap 20 with the water may also be recirculated to the stack 10 along the recirculation line 22 with the hydrogen. The recirculated oxygen may cause a local mixing interface between hydrogen and oxygen at the anode of the stack 10, and deterioration of the unit cells forming the stack 10 may accelerated due to the local mixing interface, which may result in deterioration in durability of the stack 10.

The above information disclosed in this Background section is only for enhancement of understanding of the background of the disclosure and therefore it may contain information that does not form the prior art that is already known in this country to a person of ordinary skill in the art.

### SUMMARY OF THE DISCLOSURE

The following summary presents a simplified summary of certain features. The summary is not an extensive overview and is not intended to identify key or critical elements.

Systems, apparatuses, and methods are described for a water trap apparatus for fuel cells. A water trap apparatus for a fuel cell stack may comprise: a water trap comprising: one or more inlets configured to receive hydrogen, water, and oxygen discharged from the fuel cell stack via a discharge line between the fuel cell stack and the one or more inlets and a recirculation outlet configured to allow recirculation of contents from the water trap to the fuel cell stack via a recirculation line; a first magnet and a second magnet mounted at the one or more inlets of the water trap, wherein the first magnet and the second magnet are spaced apart from each other so as to form a first magnetic field configured to guide water to a first portion of an inside of the water trap or to the recirculation outlet, wherein the recirculation outlet is separated from the first portion; and a third magnet and a fourth magnet mounted at the recirculation outlet of the water trap, wherein the third magnet and the fourth magnet are spaced apart from each other so as to form a second magnetic field configured to guide the oxygen to the first portion of an inside of the water trap.

A method of controlling a water trap apparatus may comprise: determining, by a controller of the water trap apparatus, that the fuel cell stack is in a dry state; and controlling, by the controller based on the determining that the fuel cell stack is in the dry state, an opening and closing door to move to a position at which: a bypass line, between a discharge line from the fuel cell stack and one or more bypass inlets of a water trap of the water trap apparatus, is open; and a portion of the discharge line to one or more inlets of the water trap is closed. Based on the opening and closing door being in the position, hydrogen, water, and oxygen discharged from the fuel cell stack flow along the discharge line and the bypass line to enter the water trap via the one or more bypass inlets, and wherein the one or more bypass inlets are positioned such that hydrogen, water, and oxygen that enter the water trap via the one or more bypass inlets flow into an area where a second magnetic field is formed such that a direction of the second magnetic field is configured to: guide the water to a recirculation outlet of the water trap; and guide the oxygen to a first portion of an inside of the water trap.

A method of controlling a water trap apparatus of a fuel cell stack may comprise: determining, by a controller of the water trap apparatus, whether the fuel cell stack is in a dry state; and controlling, by the controller via a control current, a first electromagnet and a second electromagnet mounted on a water trap to form a first magnetic field, wherein the controlling of the first electromagnet and the second electromagnet comprises: based on the fuel cell stack being in the dry state, causing the control current to be a first control current configured to cause the first electromagnet and the second electromagnet to form the first magnetic field in a first direction such that the first magnetic field applies a force on water molecules to guide the water molecules to a recirculation outlet of the water trap; or based on the fuel cell stack not being in the dry state, causing the control current to be a second control current configured to cause the first electromagnet and the second electromagnet to form the first magnetic field in a second direction such that the first magnetic field applies a force on water molecules to guide the water molecules to a first portion, of an inside of the water trap, separated from the recirculation outlet, and wherein a third magnet and a fourth magnet mounted on the water trap form a second magnetic field in a direction such that the second magnetic field applies a force on oxygen molecules to guide the oxygen molecules to the first portion of the inside of the water trap.

These and other features and advantages are described in greater detail below.

### BRIEF DESCRIPTION OF THE DRAWINGS

The above and other features of the present disclosure will now be described in detail with reference to certain exemplary examples thereof illustrated in the accompanying drawings which are given hereinbelow by way of illustration only, and thus are not limitative of the present disclosure, and wherein:

FIG. 1 is a schematic view showing a water trap apparatus;

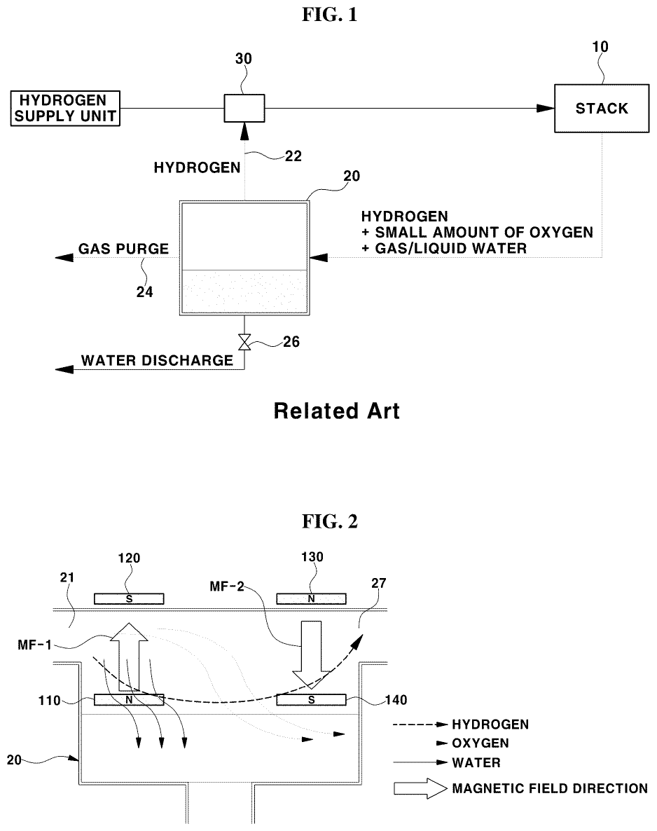

FIG. 2 is a schematic view showing a concept in which flow directions of hydrogen, water, and oxygen are controlled by magnetic fields of magnets mounted in a water trap apparatus according to a first example of the present disclosure;

FIG. 3 is a cross-sectional view showing the actual cross-sectional shape of the water trap apparatus according to the first example of the present disclosure, illustrating an operation in which the water and the oxygen are guided to the lower portion of a water trap and the hydrogen is recirculated to a stack by the magnetic fields of the magnets;

FIG. 4 is a cross-sectional view showing a state in which bypass inlets and a bypass line are further formed and an opening and closing door is operated to open a discharge line and simultaneously close the bypass line in the water trap apparatus according to the first example of the present disclosure;

FIG. 5 is a cross-sectional view showing a state in which the bypass inlets and the bypass line are further formed and the opening and closing door is operated to open the bypass line and simultaneously close the discharge line in the water trap apparatus according to the first example of the present disclosure;

FIG. 6 is a flowchart illustrating a method of controlling the water trap apparatus according to the first example of the present disclosure;

FIGS. 7 and 8 are schematic views showing a concept in which flow directions of hydrogen, water, and oxygen are controlled by magnetic fields of electromagnets mounted in a water trap apparatus according to a second example of the present disclosure;

FIG. 9 is a cross-sectional view showing the actual cross-sectional shape of the water trap apparatus according to the second example of the present disclosure, illustrating an operation in which the water and the oxygen are guided to the lower portion of a water trap and hydrogen is recirculated to a stack by the magnetic fields of the electromagnets;

FIG. 10 is a cross-sectional view showing the actual cross-sectional shape of the water trap apparatus according to the second example of the present disclosure, illustrating an operation in which the oxygen is guided to the lower portion of the water trap and a portion of the water is recirculated to the stack together with the hydrogen by the magnetic fields of the electromagnets; and

FIGS. 11 and 12 are flowcharts illustrating a method of controlling the water trap apparatus according to the second example of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Specific structural or functional descriptions set forth in the examples of the present disclosure will be merely exemplarily given to describe the examples depending on the concept of the present disclosure, and the examples depending on the concept of the present disclosure may be embodied in different forms. Further, the present disclosure should not be construed as being limited to the examples set forth herein, and it will be understood that the present disclosure includes all modifications, equivalents, or substitutes included in the spirit and technical scope of the disclosure.

In the following description of the examples, terms, such as “first” and “second,” and the like, are used only to describe various elements, and these elements should not be construed as being limited by these terms. These terms are used only to distinguish one element from other elements. For example, a first element described hereinafter may be termed a second element, and similarly, a second element described hereinafter may be termed a first element, without departing from the scope of the disclosure.

If an element or layer is referred to as being “connected to” or “coupled to” another element or layer, it may be directly connected or coupled to the other element or layer, or intervening elements or layers may be present. In contrast, if an element or layer is referred to as being “directly connected to” or “directly coupled to” another element or layer, there may be no intervening elements or layers present. Other words used to describe relationships between elements should be interpreted in a like fashion, e.g., “between” versus “directly between,” “adjacent” versus “directly adjacent,” etc.

Wherever possible, the same reference numbers will be used throughout the following description to refer to the same or like parts. The terminology used herein is for the purpose of describing particular examples only and is not intended to be limiting. As used herein, singular forms may be intended to include plural forms as well, unless the context clearly indicates otherwise. The terms “comprising,” “including,” “having” and the like are inclusive and therefore specify the presence of stated features, integers, steps, operations, elements, components, and/or combinations thereof, but do not preclude the presence or addition of one or more other features, integers, steps, operations, elements, components, and/or combinations thereof.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B. “One or more of” is synonymous with “at least one of” herein.

The term “about” in relation to a reference numerical value, and its grammatical equivalents as used herein, can include the reference numerical value itself and a range of values plus or minus 10% from that reference numerical value. For example, the term “about 10” includes 10 and any amount from and including 9 to 11. In some cases, the term “about” in relation to a reference numerical value can also include a range of values plus or minus 10%, 9%, 8%, 7%, 6%, 5%, 4%, 3%, 2%, or 1% from that reference numerical value. In some embodiments, “about” in connection with a number or range measured by a particular method indicates that the given numerical value includes values determined by the variability of that method.

The expression “based on” as used herein is intended to describe one or more factors that influence an act or operation of determining or deciding described in a phrase or sentence including that expression, and this expression does not exclude any additional factors that influence the act or operation of determining or deciding.

Depending on the context, the expression “configured to” as used herein may have meanings such as “set to”, “with the ability to”, “modified to”, “made to”, “to be able to”, etc. This expression is not limited to the meaning of “specially designed in hardware to”. For example, a processor configured to perform a specific operation may refer to a generic purpose processor capable of performing the specific operation by executing software, or to a special purpose computer structured through programming to perform the specific operation.

Unless otherwise defined, the terms used herein, including technical or scientific terms, may have meanings generally understood by those skilled in the art to which the present disclosure belongs. A singular expression used herein may include the meaning of the plural unless otherwise stated in the context, which also applies to the singular expression described in the claims.

In the present disclosure, one or more control devices (e.g., a controller, a control unit, etc.) may be realized as one or more processors and a memory. The “one or more processors” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like.

A controller may include a communication device/interface communicating with other controllers or one or more sensors sensor to control one or more functions and/or operations in charge, a memory storing an operation system, a logic command, and input/output information, and/or one or more processors performing determination, calculation, and decision necessary for controlling the function in charge. A controller may include, for example, a processor, a central processing unit (CPU), a microchip, a logic, an application-specific integrated circuit (ASIC), memory, etc. A controller may manipulate and/or control other components in the system (e.g., other components of a vehicle).

The controller may include one or more communication interfaces and/or user interfaces. The communication interface(s) (also referred to as communication device(s), communicator(s), communication module(s), communication unit(s), etc.) may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc. A user interface may be a device through which a human user can interact with a device. The user interface may include an input interface that can receive an input from the human user and/or an output interface through which data or information can be output to the human user. An input interface may include, for example, a button, a knob, a toggle, a switch, a dial, a slider, a keyboard, a touchscreen, a microphone, a camera, a wheel, a pedal, a lever, etc. An output interface may include, for example, a light, a lamp, an indicator, a screen, a display, a console, a meter, a gauge, a speaker, etc.

Magnets herein may be implemented as permanent magnets or as electromagnets, for example, except where specified as either permanent magnets or. Using permanent magnets may have a benefit of maintaining their magnetic properties without power provided by an external power source, but magnetic properties of permanent magnets cannot be controlled/adjusted as electromagnets.

Hereinafter, examples of the present disclosure will be described in detail with reference to the accompanying drawings.

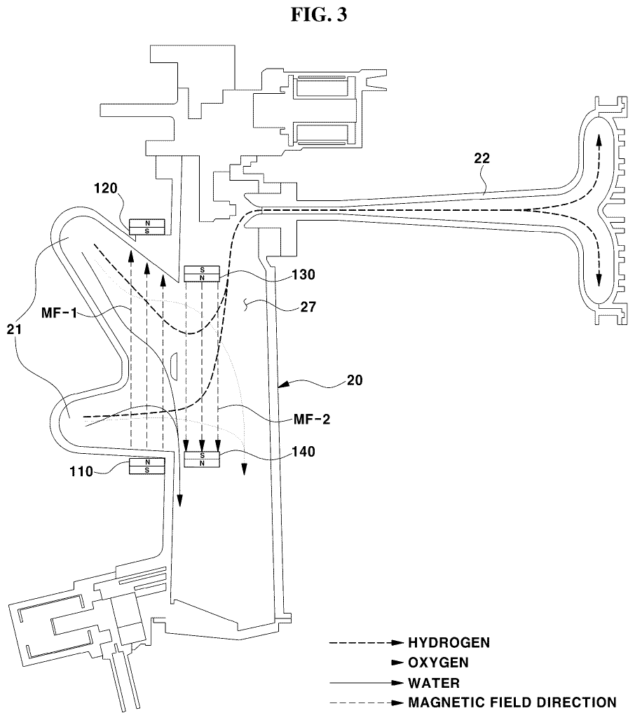

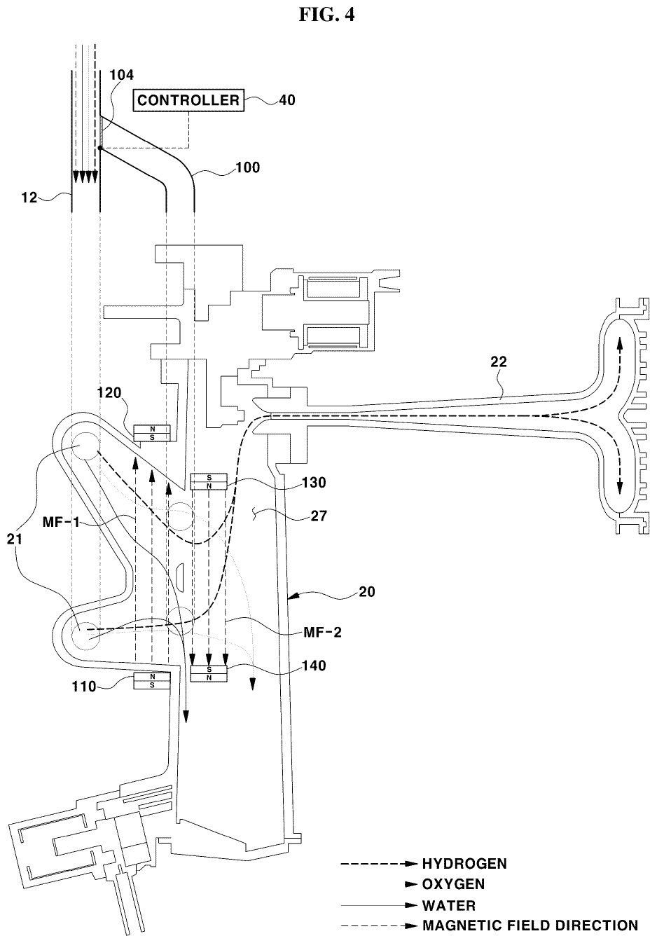

FIG. 2 is a schematic view showing a concept in which flow directions of hydrogen, water, and oxygen are controlled by magnetic fields of magnets mounted in a water trap apparatus according to a first example of the present disclosure, and FIG. 3 is a cross-sectional view illustrating the actual cross-sectional shape of the water trap apparatus according to the first example of the present disclosure.

As shown in FIGS. 2 and 3, a first magnet 110 and a second magnet 120 may be mounted around one or more inlets 21 of a water trap 20 (e.g., into which hydrogen, water, and oxygen discharged from a stack 10 may flow). The first magnet 110 and the second magnet 120 herein may be spaced apart from each other to form a first magnet field MF-1 that guides the water to the lower portion of the inside of the water trap 20 (e.g., a first portion of the inside of the water trap 20, where the first portion does not include the recirculation outlet).

For example, the first magnet field MF-1 may be formed in a direction from the N pole of the first magnet 110 toward the S pole of the second magnet 120. A resulting force acting on water molecules due to the first magnetic field MF-1 may act in the direction opposite to the direction of the first magnetic field MF-1, so that the water may be guided to the lower portion of the inside of the water trap 20 and be captured therein. Forcing the water towards/into the water trap 20 (e.g., away from the inlet 21 and/or a hydrogen recirculation outlet 27) may reduce/prevent the water from being recirculated to the stack 10 through/via a hydrogen recirculation outlet 27 of the water trap 20.

A third magnet 130 and a fourth magnet 140 may be mounted at designated positions around the hydrogen recirculation outlet 27 (e.g., through which the hydrogen in the water trap 20 may be recirculated to the stack 10). The third magnet 130 and the fourth magnet may be spaced apparat from each other so as to form a second magnetic field MF-2 for guiding the oxygen to the lower portion of the inside of the water trap 20.

The second magnet field MF-2 may be formed in a direction from the N pole of the third magnet 130 toward the S pole of the fourth magnet 140. A resulting force acting on oxygen molecules due to the second magnetic field MF-2 may act in the same direction as the direction of the second magnetic field MF-2, so that the oxygen may be guided to the lower portion of the inside of the water trap 20 and captured therein. Forcing the oxygen towards/into the water trap (e.g., away from the inlet 21 and/or the hydrogen recirculating outlet 27) may reduce and/or prevent the oxygen from being recirculated to the stack 10 through the hydrogen recirculation outlet 27 of the water trap 20.

The force acting on the oxygen molecules (e.g., due to the second magnetic field MF-2) may act in the same direction as the direction of the second magnetic field MF-2 due to the paramagnetic characteristic of the oxygen molecules. The force acting on the water molecules (e.g., by the first magnetic field MF-1) may act in the direction opposite to the direction of first magnetic field MF-1 due to the diamagnetic characteristics of the water molecules.

The force Fₘ acting on a molecule due to a magnetic field (e.g., on the water molecules due to the first magnetic field MF-1 and/or acting on the oxygen molecules due to the second magnetic field MF-2) may be determined according to Equation 1.

$${F}_{m} = \frac{x}{{u}_{0}} \times B \times Δ B \qquad [ Equation 1 ]$$

In Equation 1, B represents a magnetic field density [T], x represents magnetic susceptibility of the molecule, and μ0 represents magnetic permeability, respectively.

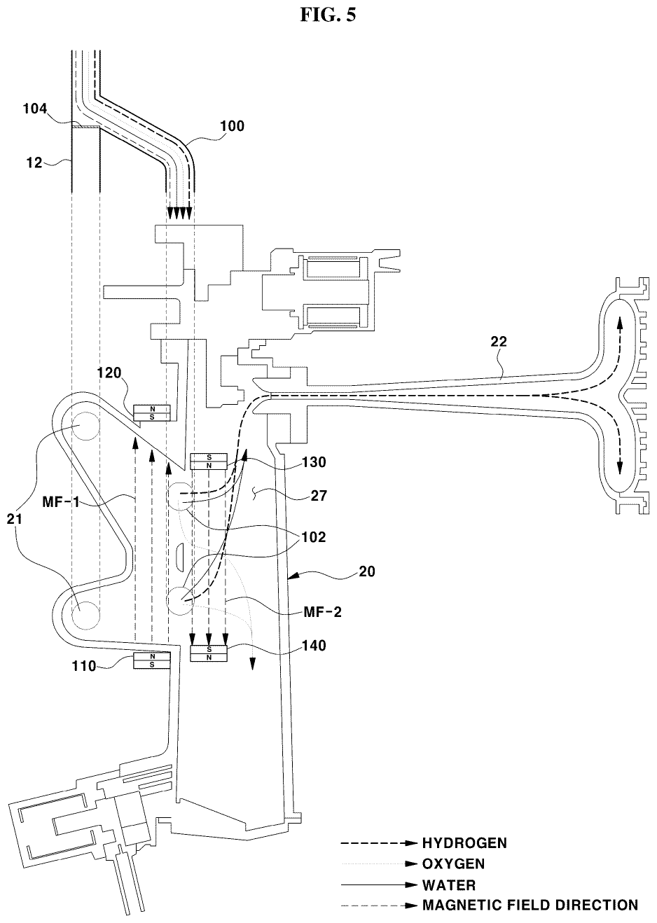

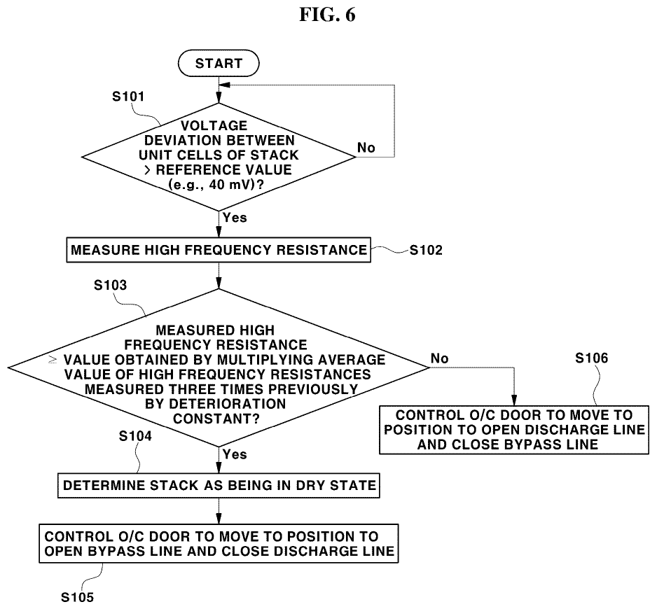

Referring to FIGS. 4 and 5, bypass inlets 102 may be further formed at a position away from an area where the first magnetic field MF-1 acts at the inlets 21 of the water trap 20. For example, the bypass inlets 102 may be formed at a position between the area where the first magnetic field MF-1 acts and an area where the second magnetic field MF-2 acts.

A bypass line 100 may be connected between a discharge line 12 connected to the stack 10 and the inlets 21 of the water trap 20 so that hydrogen, water, and oxygen discharged from the stack 10 flow therethrough, and the bypass inlets 102.

An opening and closing door 104 may be operated (e.g., by a controller 40) to open the discharge line 12 and (e.g., simultaneously) close the bypass line 100 and/or operated to open the bypass line 100 and (e.g., simultaneously) close the discharge line 12. The opening and/closing door 104 may be operated by/based on a control signal received from a controller 40 (e.g., mounted on the bypass line 100).

The controller 40 may be configured to control the opening and closing door 104 to move to a position to open the bypass line 100 and close the discharge line 12 upon/based on determining that the stack 10 is in a dry state. The controller 40 may be configured to control the opening and closing door 104 to move to a position to open the discharge line 12 and close the bypass line 100 upon/based on determining that the stack 10 is not in the dry state and/or is in a flooded state.

Accordingly, if the stack 10 is in the dry state, controlling the opening and closing door 104 to move to the position to open the bypass line 100 and close the discharge line 12 (e.g., under the control of the controller 40) may cause hydrogen, water, and a small amount of oxygen discharged from the stack 10 to flow, via the bypass line 100, into the bypass inlets 102 into the water trap 20.

If/when the water flowing into the bypass inlets 102 passes through the area of the second magnetic field MF-2 (e.g., rather than the first magnetic field MF-1, as the first magnetic field MF-1 is bypassed), a force acting on the water molecules due to the second magnetic field MF-2 acts in the direction opposite to the direction of the second magnetic field MF-2, as shown in FIG. 5, thereby guiding the water to the hydrogen recirculation outlet 27 of the water trap 20 to be recirculated to an anode of the stack 10, and thus resolving the dry state of the stack 10.

If/when the stack is not in the dry state and/or is in the flooded state, controlling the opening and closing door 104 to move to the position to open the discharge line 12 and close the bypass line 100 (e.g., under the control of the controller 40) may cause hydrogen, water, and a small amount of oxygen discharged from the stack 10 to flow, via the discharge line 12, into the inlets 20 into the water trap 20.

If/when the water is flowing into the inlets 21, the force acting on the water molecules due to the first magnetic field MF-1 may acts in the direction opposite to the direction of the first magnetic field MF-1, as shown in FIG. 4, thereby guiding the water to the lower portion of the inside of the water trap 20 to be captured therein, and thus preventing the water from being recirculated to the stack 10 through the hydrogen recirculation outlet 27 of the water trap 20.

Also, or alternatively, regardless of whether the stack 10 is in the dry state, if oxygen flows into the water trap 20 the force acting on the oxygen molecules due to the second magnetic field MF-2 acts in the same direction as the direction of the second magnetic field MF-2, thereby guiding the oxygen to the lower portion of the inside of the water trap 20 to be captured therein, and thus preventing the oxygen from being recirculated to the stack 10 through the hydrogen recirculation outlet 27 of the water trap 20.

Here, a method of controlling the water trap apparatus according to the first example of the present disclosure will be described as follows.

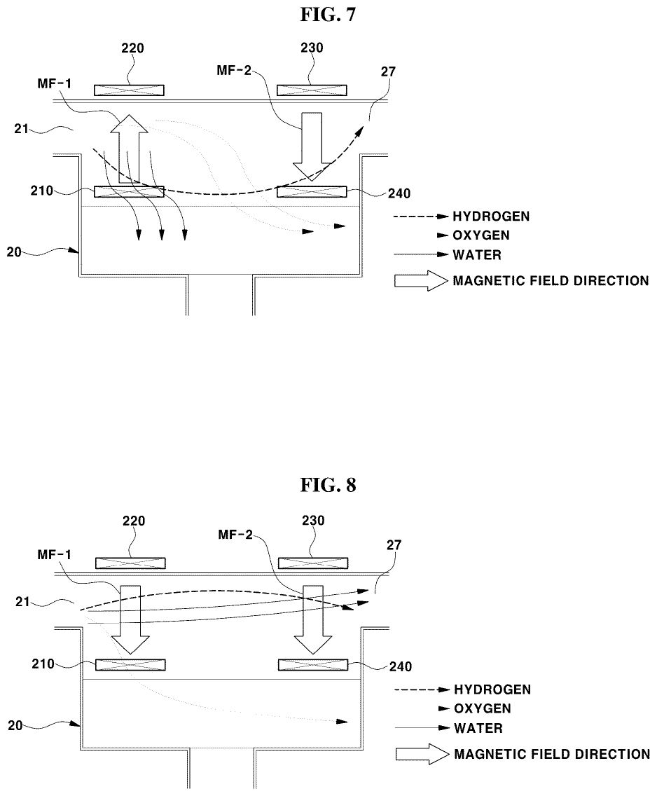

FIG. 6 is a flowchart illustrating the method of controlling the water trap apparatus according to the first example of the present disclosure. For convenience, FIG. 6 is described by way of an example in which the steps are performed by a processor circuit. One, some, or all steps of the example method of FIG. 6, or portions thereof, may be performed by one or more other circuits. One or some, steps of the example method of FIG. 6 may be omitted, performed in other orders, and/or otherwise modified, and/or one or more additional steps may be added.

The controller 40 may determine whether the stack 10 is in the dry state according to the method in FIG. 6, for example.

For example, a determination may be made as to whether a voltage deviation between unit cells of the stack 10 satisfies a first criteria (e.g., exceeds a reference value (e.g., about 40 mV)) (S101). Voltages of unit cells of the stacks may be monitored/measured (e.g., by one or more sensors, such as voltage sensors). The monitored/measured voltages, and/or information based thereon, may be received by the controller 40 from the one or more voltage sensors. For example, the information may comprise an indication that a voltage deviation between unit cells of the stack 10 satisfy the first criteria, and/or the controller 40 may determine based on the monitored/measured voltages whether a voltage deviation between unit cells of the stack 10 satisfy the first criteria. If the voltage deviation between unit cells of the stack (e.g., a difference between two cells in the stack, a standard deviation across the cells in the stack, a difference between any cell in the stack and an average voltage across the stack, etc.) does not satisfy the first criteria (e.g., is equal to or less than a reference value) (S101—No), the controller may continue to check whether the voltage deviation between unit cells of the stack satisfy the first criteria.

If the voltage deviation between unit cells of the stack (e.g., a difference between two cells in the stack, a standard deviation across the cells in the stack, a difference between any cell in the stack and an average voltage across the stack, etc.) satisfy the first criteria (e.g., exceeds a reference value) (S101—Yes), the controller may measure/determine a high frequency resistance of the stack, which may refer to the cell resistance of the stack 10 (S102). For example, the controller 40 may, based on determining the voltage deviation between unit cells of the stack exceeds the reference value, the controller may control one or more sensors to measure and/or determine the high frequency resistance.

The measured/determined high frequency resistance may be compared with a second criteria to determine whether the stack is in a dry state. For example, if the measured/determined high frequency resistance satisfies the second criteria, such as being greater than or equal to a deterioration threshold based on a reference resistance and/or previous resistance values. For example, the deterioration threshold may be a value obtained by multiplying the average value of high frequency resistances measured three times previously by a deterioration constant (S103). If the measured/determined high frequency resistance satisfies the second criteria, such as being greater than or equal to the deterioration threshold, (S203—Yes), a determination may be made that the stack 10 is in the dry state (e.g., based on the measured high frequency resistance being greater than or equal to the value obtained by multiplying the average value of the high frequency resistances measured three times previously by the deterioration constant as a result of the comparison) (S104).

The high frequency resistance (HFR) refers to the resistance of cells forming the fuel cell stack 10. A large value of the high frequency resistance may indicate an uneven hydration state of an electrolyte membrane in the stack 10 is uneven. The stack 10 may be determined, based on the HFR, as being in the dry state. A large value of high frequency resistance may imply a value greater than preset resistance value. For example, the preset resistance value may not be specifically limited to values determined by the designer. Accordingly, if the high frequency resistance measured in S102 is greater than or equal to a value obtained by multiplying the average value of the high frequency resistance measured three times by the deterioration constant, it may be determined that the stack is in a dry state.

If the stack 10 is determined as being in the dry state, the controller 40 may control the opening and closing door 104 to open the bypass line 100 and close the discharge line 12 (S105).

Accordingly, hydrogen, water, and a small amount of oxygen discharged from the stack 10 may flow into the bypass inlets 102 in the water trap 20 through the bypass line 100.

Because the water flowing into the bypass inlets 102 passes through the area of the second magnetic field MF-2 (e.g., rather than the first magnetic field MF-1), the force acting on the water molecules due to the second magnetic field MF-2 acts in the direction opposite to the direction of the second magnetic field MF-2, as shown in FIG. 5, thereby guiding the water to the hydrogen recirculation outlet 27 to be recirculated to the anode of the stack 10 (e.g., together with the hydrogen), thus resolving the dry state of the stack 10.

For example, a portion of the water flowing into the area where the second magnetic field MF-2 by the third magnet 130 and the fourth magnet 140 in the water trap 20 acts may be recirculated from the water trap 20 into the anode of the stack 10 together with the hydrogen in order to resolve the dry state of the stack 10, and the remainder of the water may be captured in the lower portion of the inside of the water trap 20 due to gravity.

If the measured high frequency resistance does not satisfy the second criteria (e.g., is less than the deterioration threshold, such as the value obtained by multiplying the average value of the high frequency resistances measured three times previously by the deterioration constant) (S103—No), the stack 10 may be determined as not being in the dry state, and the controller 40 may controls the opening and closing door 104 to move to the position open the discharge line 12 and simultaneously close the bypass line 100 (S106).

Accordingly, when/if hydrogen, water, and the small amount of oxygen discharged from the stack 10 may flow into the inlets 21 of the water trap 20 through the discharge line 12, the force acting on the water molecules due to the first magnetic field MF-1 acts in the direction opposite to the direction of the first magnetic field MF-1, as shown in FIG. 4, thereby guiding the water to the lower portion of the inside of the water trap 20 to be captured therein, and thus preventing the water from being recirculated to the stack 10 through the hydrogen recirculation outlet 27.

Further, regardless of whether the stack 10 is in the dry state, if the oxygen flows into the water trap 20, the force acting on the oxygen molecules due to the second magnetic field MF-2 acts in the same direction as the direction of the second magnetic field MF-2, as shown in FIGS. 4 and 5, thereby guiding the oxygen to the lower portion of the inside of the water trap 20 to be captured therein, and thus preventing the oxygen from being recirculated to the stack 10 through the hydrogen recirculation outlet 27 of the water trap 20.

Hereinafter, a water trap apparatus according to a second example of the present disclosure will be described.

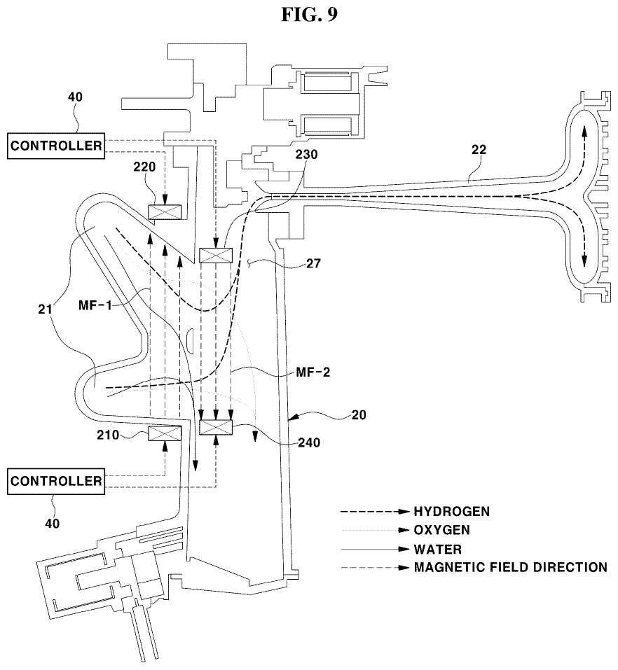

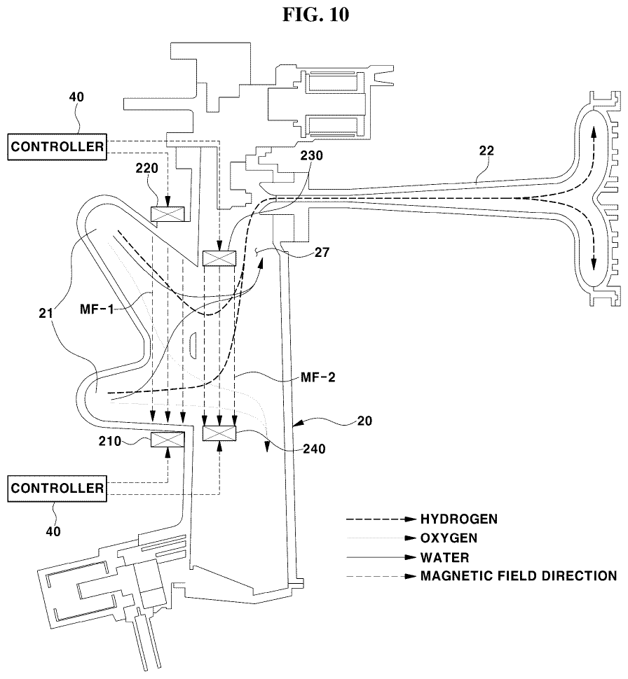

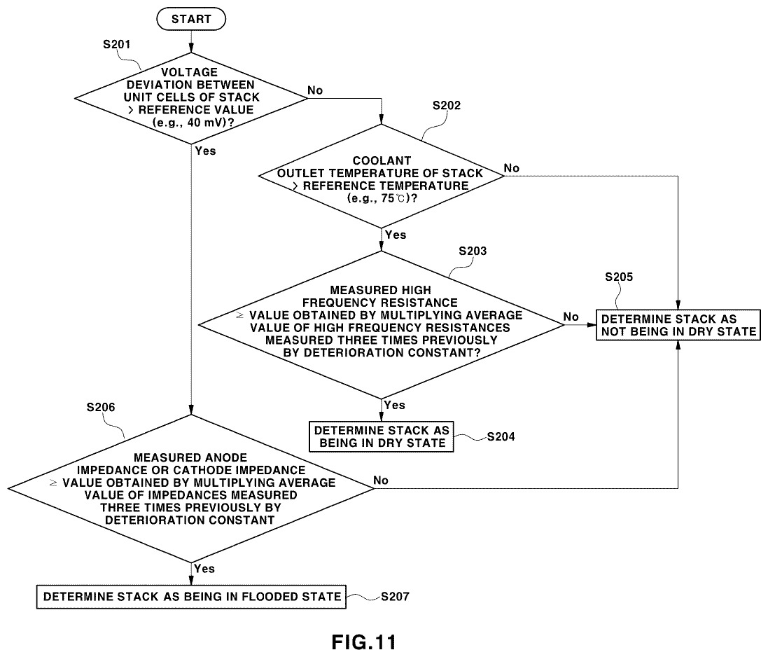

FIGS. 7 and 8 are schematic views showing a concept in which flow directions of hydrogen, water, and oxygen are controlled by magnetic fields of electromagnets mounted in a water trap apparatus according to a second example of the present disclosure, and FIGS. 9 and 10 are cross-sectional views illustrating the actual cross-sectional shape of the water trap apparatus according to the second example of the present disclosure, showing an operation in which the flow directions of the hydrogen, the water, and the oxygen are controlled by the magnetic fields of the electromagnets.

A first electromagnet 210 and a second electromagnet 220 may be mounted at designated positions of one or more inlets 21 of a water trap 20. Hydrogen, water, and oxygen discharged from a stack 10 may flow through the one or more inlets 21 into the water trap 20. The first electromagnet 210 and the second electromagnet 220, may be spaced apart from each other so as to form (e.g., based on application of signals/currents/voltages to the first electromagnet 210 and/or the second electromagnet 220) a first magnet field MF-1 that guides (e.g., based on the signals/current/voltages) the water to the lower portion of the inside of the water trap 20 or a hydrogen recirculation outlet 27.

A third electromagnet 230 and a fourth electromagnet 240 may be mounted at a hydrogen recirculation outlet 27. The hydrogen in the water trap 20 may be discharged to be recirculated to the stack 10. The third electromagnet 230 and the fourth electromagnet 240 may be spaced apart from each other so as to form (e.g., based on application of signals/currents/voltages to the third electromagnet 230 and/or the fourth electromagnet 240) a second magnetic field MF-2 for guiding (e.g., based on the signals/current/voltages) the oxygen to the lower portion of the inside of the water trap 20. Also, or alternatively, the third electromagnet 230 and/or the fourth electromagnet 240 may comprise or be replace/implemented as permanent magnets in this example. The third a.

Referring to FIGS. 7 and 9, the first magnetic field MF-1 may be formed in a direction from the first electromagnet 210 toward the second electromagnet 220 based on a applied first current controlled by a controller 40. The force acting on the water molecules due to the first magnetic field MF-1 may act in a direction opposite to the direction of the first magnetic field MF-1, thereby guiding the water flowing from the stack 10 into the water trap 20 to the lower portion of the inside of the water trap 20 to be captured therein. Application of the first current results in the MF-1 capable of preventing the water from being recirculated to the stack 10 through the hydrogen recirculation outlet 27 of the water trap 20.

If the stack 10 is in the dry state (e.g., as shown in FIGS. 8 and 10), the first magnetic field MF-1 may be formed in a direction from the second electromagnet 220 toward the first electromagnet 210 by application of a second current controlled by the controller 40. The force acting on the water molecules due to the first magnetic field MF-1 acts in the direction opposite to the direction of the first magnetic field MF-1, thereby guiding the water to the hydrogen recirculation outlet 27 to be recirculated to the anode of the stack 10 together with the hydrogen, and thus being capable of resolving the dry state of the stack 10.

Referring to FIGS. 7 to 10, the second magnetic field MF-2 may be formed in a direction from the third electromagnet 230 toward the fourth electromagnet 240 (e.g., by current control of the controller 40), and force acting on oxygen molecules due to the second magnetic field MF-2 acts in the same direction as the direction of the second magnetic field MF-2, thereby being capable of preventing the oxygen from being recirculated to the stack 10 through the hydrogen recirculation outlet 27 of the water trap 20.

Here, an example of a method of controlling the water trap apparatus according to the second example of the present disclosure will be described as follows.

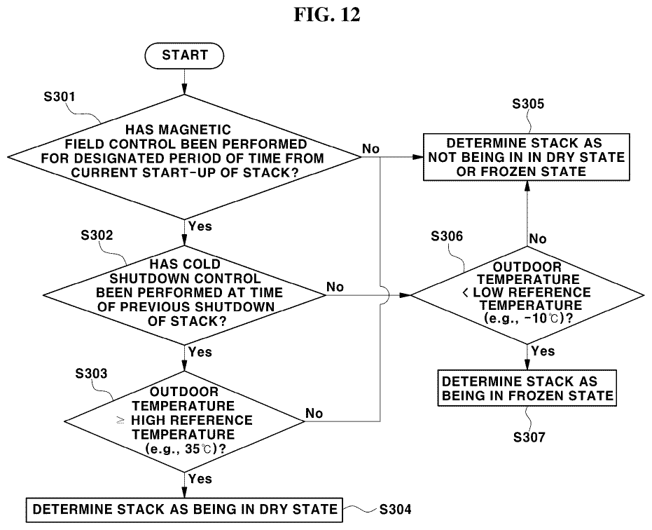

FIG. 11 is a flowchart illustrating an example of the method of controlling the water trap apparatus according to the second example of the present disclosure. For convenience, FIG. 11 is described by way of an example in which the steps are performed by a processor circuit. One, some, or all steps of the example method of FIG. 11, or portions thereof, may be performed by one or more other circuits. One or some, steps of the example method of FIG. 11 may be omitted, performed in other orders, and/or otherwise modified, and/or one or more additional steps may be added.

The controller 40 may determine whether the stack 10 is in the dry state during the operation of the stack 10.

The controller 40 may determine whether a voltage deviation between unit cells of the stack 10 satisfies a first threshold (e.g., exceeds a reference value during the operation of the stack) (S201). If the voltage deviation (e.g., determined as described with respect to FIG. 6) does not satisfy the first threshold (S201—No), a determination may be made as to whether a coolant outlet temperature of the stack 10 satisfies a second threshold (e.g., is higher than a reference temperature (e.g., 75° C.)) (S202). If the coolant outlet temperature satisfies the second threshold (S202—Yes), a cell resistance of the stack 10 (e.g., a high frequency resistance) may be determined. If the coolant outlet temperature does not satisfy the second threshold (S203—No), the measured/determined cell resistance (e.g., high frequency resistance) may be compared with a deterioration threshold (e.g., with a value obtained by multiplying the average value of high frequency resistances measured three times previously by a deterioration constant) (S203). If the measured/determined cell resistance satisfies (e.g., is greater than or equal to) the deterioration threshold (S203—Yes), the stack 10 may be determined to be in the dry state (S204).

If the coolant outlet temperature does not satisfy the second threshold (e.g., is lower than the reference temperature) (S203—No), the stack 10 may be determined as not being in the dry state (S205).

If the voltage deviation between the unit cells of the stack 10 satisfies the first threshold (e.g., is determined as being greater than the reference value) (S201—No), anode impedance and/or cathode impedance of the stack 10 may be measured/determined and compared to an impedance deterioration threshold (e.g., a value obtained by multiplying the average value of impedances measured three times previously by a deterioration constant) (S206). For example, the controller 40 may receive a measured anode and/or cathode impedance from an impedance sensor (e.g., voltage sensor/multimeter) and/or an indication that a measured anode and/or cathode impedance satisfies the impedance deterioration threshold from an impedance sensor The stack 10 may be determined as being in the flooded state (S207) if the measured anode impedance or cathode impedance satisfies the deterioration threshold (S206—Yes).

If the stack 10 is determined as being in the dry state in operation S204, as shown in FIGS. 8 and 10, the first magnetic field MF-1 may be controlled to be formed in the direction from the second electromagnet 220 toward the first electromagnet 210 (e.g., by current control of the controller 40).

Accordingly, hydrogen, water, and oxygen discharged from the stack 10 may flow into the one or more inlets 21 of the water trap 20. The first magnetic field MF-1 formed in the direction from the second electromagnet 220 toward the first electromagnet 210 may act on water in a direction opposite to the direction of the first magnetic field MF-1, thereby guiding the water to the hydrogen recirculation outlet 27 of to be recirculated to the anode of the stack 10 together with the hydrogen, and thus resolving/improving the dry state of the stack 10.

If the stack 10 is determined as not being in the dry state (S205), or if the stack 10 is determined as being in the flooded state (S207), as shown in FIGS. 7 and 9, the first magnetic field MF-1 may be formed in the direction from the first electromagnet 210 toward the second electromagnet 220 (e.g., by current control of the controller 40).

The force acting on the water molecules due to the first magnetic field MF-1 may acts in the direction opposite to the direction of the first magnetic field MF-1, thereby guiding the water to the lower portion of the inside of the water trap 20 to be captured therein. The water may be prevented from being recirculated to the stack 10 through the outlet 27 for hydrogen recirculation.

Regardless of the dry state of the stack, as shown in FIGS. 7 to 10, the second magnetic field MF-2 may be formed in the direction from the third electromagnet 230 toward the fourth electromagnet 240 (e.g., by current control of the controller 40, or the third and fourth electromagnets 230 and 240 may be implemented instead as permanent magnets).

The force, acting on the oxygen molecules in the water trap 20, due to the second magnetic field MF-2 formed in the direction from the third electromagnet 230 toward the fourth electromagnet 240 acts in the same direction as the direction of the second magnetic field MF-2. The second magnetic field MF-2 may prevent the oxygen from being recirculated to the stack 10 through the outlet 27.

Here, another example of the method of controlling the water trap apparatus according to the second example of the present disclosure will be described as follows.

FIG. 12 is a flowchart illustrating another example of the method of controlling the water trap apparatus according to the second example of the present disclosure. For convenience, FIG. 12 is described by way of an example in which the steps are performed by a processor circuit. One, some, or all steps of the example method of FIG. 12, or portions thereof, may be performed by one or more other circuits. One or some, steps of the example method of FIG. 12 may be omitted, performed in other orders, and/or otherwise modified, and/or one or more additional steps may be added.

First, the controller 40 determines whether the stack 10 is in the dry state upon initial start-up of the stack 10.

The controller 40 may determine whether magnetic field control in which the first magnetic field MF-1 is formed in the direction from the first electromagnet 210 toward the second electromagnet 220 and the second magnetic field MF-2 is formed in the direction from the third electromagnet 230 toward the fourth electromagnet 240 satisfies a threshold (e.g., has been performed for a designated period of time (e.g., from the current start-up time of the stack 10)) (S301). If the magnetic field control satisfies the threshold (S301—Yes), a determination may be made as to whether cold shutdown (CSD) control has been performed (e.g., associated with/at the time of the previous shutdown of the stack 10) (S302). If CSD control was performed at the time of previous shutdown (S302—Yes), a determination may be mad as to whether an outdoor (e.g., external to the vehicle, external to the fuel cell stack 10, etc.) temperature satisfies a high temperature threshold (e.g., is higher than or equal to a high reference temperature (e.g., 35° C.)) (S303). For example, the controller 40 may receive outdoor temperature measurements from a temperature sensor and/or receive an indication that a measured outdoor temperature satisfies the high temperature threshold. If the outdoor temperature satisfies the temperature threshold (S303—Yes), the stack 10 may be determined as being in the dry state (E304).

The cold shutdown (CSD) control may be a control signal/operation that forcibly discharges water in the stack 10, for example to prevent freezing of the stack 10 when a fuel cell system is shut down. If the outdoor temperature is higher than or equal to the high reference temperature after the water in the stack 10 has been forcibly discharged by the cold shutdown control, the stack 10 may be determined as being in the dry state (S304).

If the stack 10 is determined as being in the dry state (S304), as shown in FIGS. 8 and 10, the first magnetic field MF-1 may be controlled, by the controller 40 controlling current applied to the first electromagnet 210 and the second electromagnet 220, to be formed in the direction from the second electromagnet 220 toward the first electromagnet 210.

Hydrogen, water, and oxygen discharged from the stack 10 may flow into the one or more inlets 21 of the water trap 20. The force acting on the water molecules due to the first magnetic field MF-1 formed in the direction from the second electromagnet 220 toward the first electromagnet 210 acts in the direction opposite to the direction of the first magnetic field MF-1 (e.g., as shown in FIGS. 8 and 10). As such the first magnetic field MF-1 may guide the water to the hydrogen recirculation outlet 27 to be recirculated to the anode of the stack 10 together with the hydrogen, and thus resolving the dry state of the stack 10.

Based on determining that the cold shutdown control has not been performed (S302—No), a determination may be made as to whether the outdoor temperature satisfies a low temperature threshold (e.g., is lower than a low reference temperature (e.g., −10° C.)) (S306). If the outdoor temperature satisfies the low temperature threshold (e.g., is lower than the low reference temperature) (S306—Yes), the stack 10 may be determined as being in a frozen state (S307).

If the stack 10 is determined as being in the frozen state, as shown in FIGS. 8 and 10, the first magnetic field MF-1 may be formed, by a second current controlled by the controller 40, in the direction from the second electromagnet 220 toward the first electromagnet 210. The force acting on the water molecules due to the first magnetic field MF-1 acts in the direction opposite to the direction of the first magnetic field MF-1, thereby guiding the water to the hydrogen recirculation outlet 27 to be recirculated to the anode of the stack 10 together with the hydrogen, and thus resolving the frozen state of the stack 10 (e.g., because a frozen part in the stack 10 may be melted by the recirculated water).

Based on determining that the magnetic field control has not been performed for the designated period of time from the current start-up time of the stack 10 (S301—No), the stack 10 may be determined as being not in the dry state (S305). Also, if the outdoor temperature does not satisfy the high temperature threshold (S303—No), or if the outdoor temperature does not satisfy the low temperature threshold (S306—No), the stack 10 may be determined as being not in the dry state or the frozen state (S305).

If the stack 10 is determined as being not in the dry state or the frozen state (e.g., as shown in FIGS. 7 and 9), magnetic field control in which the first magnetic field MF-1 is controlled, by a controller 40 controlling a first current applied to the first electromagnet 210 and the second electromagnet 220, to be formed in the direction from the first electromagnet 210 toward the second electromagnet 220 and the second magnetic field MF-2 is controlled, by the controller 40 controlling a second current applied to the third electromagnet 230 and the fourth electromagnet 240, to be formed in the direction from the third electromagnet 230 toward the fourth electromagnet 240.

The force acting on the water molecules due to the first magnetic field MF-1 acts in the direction opposite to the direction of the first magnetic field MF-1 so as to guide the water flowing from the stack 10 into the water trap 20 to the lower portion of the inside of the water trap 20 to be captured therein, and the force acting on the oxygen molecules due to the second magnetic field MF-2 acts in the same direction as the direction of the second magnetic field MF-2 so as to guide the oxygen to the lower portion of the inside of the water trap 20 to be captured therein, thereby preventing the water and the oxygen from being recirculated to the stack 10 through the hydrogen recirculation outlet 27 of the water trap 20.

The present disclosure has been made in an effort to solve various problems associated with prior art. The present disclosure provides a water trap apparatus for fuel cells and a method of controlling the same, in which magnetic bodies, such as magnets or electromagnets, are mounted opposite to each other at inlets of a water trap into which hydrogen, water, and oxygen flow and an outlet of the water trap from which the hydrogen is discharged to be recirculated to a stack, and thus, force due to a magnetic field formed by the magnetic bodies acts on oxygen molecules in the same direction as the direction of the magnetic field and force due to another magnetic field formed by the magnetic bodies acts on water molecules in the direction opposite to the direction of the magnetic field, so as to prevent the water and the oxygen from being recirculated to the stack and to allow the water and the oxygen to be captured in the water trap.

In an example, the present disclosure provides a water trap apparatus for fuel cells including a stack, and a water trap configured such that hydrogen, water, and oxygen discharged from the stack flows thereinto, wherein a first magnet and a second magnet are mounted at inlets of the water trap to be spaced apart from each other so as to form a first magnetic field configured to guide the water to a lower portion of an inside of the water trap, and a third magnet and a fourth magnet are mounted at a hydrogen recirculation outlet of the water trap, configured to discharge the hydrogen in the water trap to recirculate the hydrogen to the stack, to be spaced apart from each other so as to form a second magnetic field configured to guide the oxygen to the lower portion of the inside of the water trap.

In an example, the first magnetic field may be formed in a direction from an N pole of the first magnet toward an S pole of the second magnet, and force acting on water molecules due to the first magnetic field acts in a direction opposite to a direction of the first magnetic field, so that the water is guided to the lower portion of the inside of the water trap and captured therein.

In another example, the second magnetic field may be formed in a direction from an N pole of the third magnet toward an S pole of the fourth magnet, and force acting on oxygen molecules due to the second magnetic field acts in the same direction as a direction of the second magnetic field, so that the oxygen is guided to the lower portion of the inside of the water trap and captured therein.

In still another example, bypass inlets may be further formed at a position away from an area where the first magnetic field acts at the inlets of the water trap, and a bypass line may be further connected between a discharge line connected to the stack and the inlets of the water trap so that the hydrogen, the water, and the oxygen discharged from the stack flow therethrough, and the bypass inlets.

In yet another example, an opening and closing door operated to open the discharge line and simultaneously close the bypass line or operated to open the bypass line and simultaneously close the discharge line by a control signal from a controller may be mounted on the bypass line.

In still yet another example, the controller may be configured to control the opening and closing door to move to a position configured to open the bypass line and simultaneously close the discharge line if the stack is in a dry state, and to control the opening and closing door to move to a position configured to open the discharge line and simultaneously close the bypass line if the stack is not in the dry state.

In another example, the present disclosure provides a method of controlling a water trap apparatus including determining, by a controller, whether a stack is in a dry state, controlling, by the controller, an opening and closing door mounted on a bypass line to move to a position configured to open the bypass line and simultaneously close a discharge line, upon determining that the stack is in the dry state, allowing hydrogen, water, and oxygen discharged from the stack to flow along the discharge line and the bypass line, then pass through bypass inlets of a water trap, and flow into an area where a second magnetic field by a third magnet and a fourth magnet in the water trap acts, enabling force acting on water molecules due to the second magnetic field to act in a direction opposite to a direction of the second magnetic field to guide the water to a hydrogen recirculation outlet of the water trap, and enabling force acting on oxygen molecules due to the second magnetic field to act in the same direction as the direction of the second magnetic field to guide the oxygen to a lower portion of an inside of the water trap.

In an example, determining whether the stack is in the dry state may include determining whether a voltage deviation between unit cells of the stack exceeds a reference value, measuring high frequency resistance, if the voltage deviation between the unit cells exceeds the reference value, and determining that the stack is in the dry state, if the measured high frequency resistance is greater than or equal to a value obtained by multiplying an average value of high frequency resistances measured three times previously by a deterioration constant.

In another example, a portion of the water flowing into the area where the second magnetic field by the third magnet and the fourth magnet in the water trap acts may be recirculated from the water trap into the stack together with the hydrogen in order to resolve the dry state of the stack, and a remainder of the water may be captured in the lower portion of the inside of the water trap due to gravity.

In still another example, the method may further include controlling, by the controller, the opening and closing door mounted on the bypass line to move to a position configured to open the discharge line and simultaneously close the bypass line, upon determining that the stack is not in the dry state.

In still another example, the present disclosure provides a water trap apparatus for fuel cells including a stack, and a water trap configured such that hydrogen, water, and oxygen discharged from the stack flows thereinto, wherein a first electromagnet and a second electromagnet are mounted at inlets of the water trap to be spaced apart from each other so as to form a first magnetic field configured to guide the water to a lower portion of an inside of the water trap or a hydrogen recirculation outlet of the water trap, and a third electromagnet and a fourth electromagnet are mounted at the hydrogen recirculation outlet of the water trap, configured to discharge the hydrogen in the water trap to recirculate the hydrogen to the stack, to be spaced apart from each other so as to form a second magnetic field configured to guide the oxygen to the lower portion of the inside of the water trap.

In an example, the first magnetic field may be formed in a direction from the first electromagnet toward the second electromagnet by current control of a controller, and force acting on water molecules due to the first magnetic field may act in a direction opposite to a direction of the first magnetic field, so that the water is guided to the lower portion of the inside of the water trap and captured therein.

In another example, the first magnetic field may be formed in a direction from the second electromagnet toward the first electromagnet by current control of a controller, and force acting on water molecules due to the first magnetic field may act in a direction opposite to a direction of the first magnetic field, so that the water is guided to the hydrogen recirculation outlet of the water trap.

In still another example, the second magnetic field may be formed in a direction from the third electromagnet toward the fourth electromagnet by current control of a controller, and force acting on oxygen molecules due to the second magnetic field may act in the same direction as a direction of the second magnetic field, so that the oxygen is guided to the lower portion of the inside of the water trap and captured therein.

In a further example, the present disclosure provides a method of controlling a water trap apparatus including determining, by a controller, whether a stack is in a dry state, forming a first magnetic field in a direction from a second electromagnet toward a first electromagnet by current control of a controller so that water is guided to a hydrogen recirculation outlet of a water trap, upon determining that the stack is in the dry state, forming the first magnetic field in a direction from the first electromagnet toward the second electromagnet by the current control of the controller so that the water is guided to a lower portion of an inside of the water trap, upon determining that the stack is not in the dry state, and forming a second magnetic field in a direction from a third electromagnet toward a fourth electromagnet by the current control of the controller so that oxygen is guided to the lower portion of the inside of the water trap, regardless of whether the stack is not in the dry state.

In an example, determining whether the stack is in the dry state may include determining whether a voltage deviation between unit cells of the stack exceeds a reference value during operation of the stack, determining whether a coolant outlet temperature of the stack is higher than a reference temperature, if the voltage deviation between the unit cells of the stack is less than or equal to the reference value, measuring high frequency resistance as cell resistance of the stack, if the coolant outlet temperature of the stack is higher than a reference temperature, determining that the stack is in the dry state, if the measured high frequency resistance is greater than or equal to a value obtained by multiplying an average value of high frequency resistances measured three times previously by a deterioration constant, measuring anode impedance and cathode impedance of the stack, if the voltage deviation between the unit cells of the stack is higher than the reference value, and determining that the stack is in a flooded state, if the measured anode impedance or cathode impedance is higher than or equal to a value obtained by multiplying an average value of impedances measured three times previously by a deterioration constant.

In another example, determining whether the stack is in the dry state may include determining whether magnetic field control configured to form the first magnetic field in the direction from the first electromagnet toward the second electromagnet and the second magnetic field in the direction from the third electromagnet toward the fourth electromagnet has been performed for a designated period of time from a current start-up time of the stack, determining whether cold shutdown control has been performed at a time of previous shutdown the stack, upon determining that the magnetic field control has been performed, determining that the stack is in the dry state, if an outdoor temperature is higher than or equal to a high reference temperature, after determining that cold shutdown control has been performed, and determining that the stack is in a frozen state, if the outdoor temperature is lower than a low reference temperature, after determining that cold shutdown control has not been performed.

In still another example, after determining that the stack is not in the dry state, the first magnetic field may be formed in the direction from the first electromagnet toward the second electromagnet, and force acting on water molecules due to the first magnetic field may act in a direction opposite to a direction of the first magnetic field, so that the water is guided to the lower portion of the inside of the water trap and captured therein.

In yet another example, after determining that the stack is not in the dry state, the first magnetic field may be formed in the direction from the second electromagnet toward the first electromagnet, and force acting on water molecules due to the first magnetic field may act in a direction opposite to a direction of the first magnetic field, so that the water is guided to the hydrogen recirculation outlet of the water trap.

In still yet another example, the second magnetic field may be formed in the direction from the third electromagnet toward the fourth electromagnet, and force acting on oxygen molecules due to the second magnetic field may act in the same direction as a direction of the second magnetic field, so that the oxygen is guided to the lower portion of the inside of the water trap and captured therein.

The above and other aspects, features, and examples of the disclosure are discussed infra.

As is apparent from the above description, the present disclosure provides at least the following effects.

First, magnetic bodies, such as magnets or electromagnets, are mounted at designated positions of inlets and an outlet of a water trap respectively to face each other, so that, when hydrogen, water, and oxygen discharged from a stack flow into the water trap, force due to a magnetic field formed by the magnetic bodies is applied to oxygen molecules in the same direction as the direction of the magnetic field, thereby allowing the oxygen to be captured in the water trap, and thus being capable of preventing the oxygen from being recirculated to the anode of the stack.

Second, the magnetic bodies, such as magnets or electromagnets, are mounted at the designated positions of the inlets and the outlet of the water trap respectively to face each other, so that, when hydrogen, water, and oxygen discharged from the stack flow into the water trap, force due to a magnetic field formed by the magnetic bodies is applied to water molecules in the direction opposite to the direction of the magnetic field, thereby allowing the water to be captured in the water trap, and thus being capable of preventing the oxygen from being recirculated to the anode of the stack.

Third, only hydrogen discharged from the stack and flowing into the water trap is recirculated to the anode of the stack, and the water and the oxygen are prevented from being recirculated to the anode of the stack, thereby being capable of preventing acceleration of deterioration of the stack and improving durability of the stack.

Fourth, if the stack is determined as being in the dry state, a portion of the water flowing into the water trap may be recirculated to the anode of the stack together with the hydrogen by the magnetic field of the magnetic bodies, thereby being capable resolving the dry state of the stack.

Fifth, if the stack is determined as being in the frozen state, a portion of the high-temperature water flowing into the water trap may be recirculated to the anode of the stack together with the hydrogen by the magnetic field of the magnetic bodies, thereby resolving the frozen state of the stack.

Although the present disclosure has been described in detail with reference to various examples thereof, the scope of the present disclosure is not limited to the above-described examples, and it will be understood various modifications and improvements made of those skilled in the art that using the basic concept of the present disclosure defined in the following claims are also within the scope of the disclosure.

What is claimed is:

1. A water trap apparatus for a fuel cell stack, the water trap apparatus comprising:
a water trap comprising:
one or more inlets configured to receive hydrogen, water, and oxygen discharged from the fuel cell stack via a discharge line between the fuel cell stack and the one or more inlets;
a recirculation outlet configured to allow recirculation of contents from the water trap to the fuel cell stack via a recirculation line;
a first magnet and a second magnet mounted at the one or more inlets of the water trap, wherein the first magnet and the second magnet are spaced apart from each other so as to form a first magnetic field configured to guide water to a first portion of an inside of the water trap or to the recirculation outlet, wherein the recirculation outlet is separated from the first portion; and
a third magnet and a fourth magnet mounted at the recirculation outlet of the water trap, wherein the third magnet and the fourth magnet are spaced apart from each other so as to form a second magnetic field configured to guide the oxygen to the first portion of an inside of the water trap.

2. The water trap apparatus of claim 1, wherein the first magnet is mounted such that a first pole of the first magnet faces a first side of an inlet of the one or more inlets, and the second magnet is mounted such that a second pole of the second magnet faces a second side of the inlet, opposite the first side, such that the first magnetic field is formed in a direction from the first pole of the first magnet toward the second pole of the second magnet, such that a force acting on water molecules due to the first magnetic field acts in a direction opposite to a direction of the first magnetic field, so that the water is guided to the first portion of the inside of the water trap.

3. The water trap apparatus of claim 1, wherein the third magnet is mounted such that a first pole of the third magnet faces a first side of an recirculation outlet, and the fourth magnet is mounted such that a second pole of the fourth magnet faces a second side of the recirculation outlet, opposite the first side, such that the second magnetic field is formed in a direction from the first pole of the third magnet toward the second pole of the fourth magnet, such that a force acting on oxygen molecules due to the second magnetic field acts in the same direction as a direction of the second magnetic field, so that the oxygen is guided to the first portion of the inside of the water trap.

4. The water trap apparatus of claim 1, further comprising:
one or more bypass inlets formed at a position away from an area where the first magnetic field acts at the one or more inlets of the water trap; and
a bypass line connected between the discharge line and the one or more bypass inlets, wherein the bypass line is configured to allow the hydrogen, the water, and the oxygen discharged from the fuel cell stack to flow to bypass the one or more inlets.

5. The water trap apparatus of claim 4, further comprising:
a controller comprising a processor and a memory storing instructions that, when executed, configure the controller to send one or more control signals; and
an opening and closing door configured to:
based on a first control signal from the controller, open the discharge line and close the bypass line; or
based on a second control signal from the controller, open the bypass line and close the discharge line.

6. The water trap apparatus of claim 5, wherein the controller is configured to:
send, based on the fuel cell stack being in a dry state, the second control signal; or
send, based on the fuel cell stack not being in the dry state, the first control signal.

7. The water trap apparatus of claim 1, wherein at least one of the first magnet, the second magnet, the third magnet, or the fourth magnet is a permanent magnet or an electromagnet.

8. The water trap apparatus of claim 1, wherein the first magnet, the second magnet, the third magnet, and the fourth magnet are electromagnets, and
wherein the water trap apparatus further comprises a controller, comprising a processor and a memory storing instructions that, when executed, configure the water trap apparatus to generate control currents to form the first magnetic field and the second magnetic field.

9. The water trap apparatus of claim 8, wherein the first magnet and the second magnet are configured to form, based on application of a first control current, the first magnetic field in a direction from the first magnet toward the second magnet such that the first magnetic field is configured to apply a force on water molecules to guide the water towards the first portion of the inside of the water trap.

10. The water trap apparatus of claim 8, wherein the first magnet and the second magnet are configured to form, based on application of a second control current, the first magnetic field in a direction from the second magnet toward the first magnet such that the first magnetic field is configured to apply a force on water molecules to guide the water to the recirculation outlet.

11. The water trap apparatus of claim 8, wherein the third magnet and the fourth magnet are configured to form the second magnetic field in a direction from the third magnet toward the fourth magnet such that a force acting on oxygen molecules due to the second magnetic field is configured to guide the oxygen to the first portion of the inside of the water trap.

12. A method of controlling a water trap apparatus, the method comprising:
determining, by a controller of the water trap apparatus, that the fuel cell stack is in a dry state; and
controlling, by the controller based on the determining that the fuel cell stack is in the dry state, an opening and closing door to move to a position at which:
a bypass line, between a discharge line from the fuel cell stack and one or more bypass inlets of a water trap of the water trap apparatus, is open; and
a portion of the discharge line to one or more inlets of the water trap is closed,
wherein, based on the opening and closing door being in the position, hydrogen, water, and oxygen discharged from the fuel cell stack flow along the discharge line and the bypass line to enter the water trap via the one or more bypass inlets, and wherein the one or more bypass inlets are positioned such that hydrogen, water, and oxygen that enter the water trap via the one or more bypass inlets flow into an area where a second magnetic field is formed such that a direction of the second magnetic field is configured to:
guide the water to a recirculation outlet of the water trap; and
guide the oxygen to a first portion of an inside of the water trap.

13. The method of claim 12, further comprising
determining, based on a voltage deviation between unit cells of the fuel cell stack exceeding a reference value, a high frequency resistance, wherein:
the determining that the fuel cell stack is in the dry state is based on the high frequency resistance being greater than or equal to a value obtained by multiplying an average value of a plurality of previous high frequency resistances by a deterioration constant.

14. The method of claim 12, wherein the second magnetic field is configured to cause a portion of the water flowing into the area to be recirculated from the water trap to the fuel cell stack, and a remainder of the water is captured in the first portion of the inside of the water trap.

15. The method of claim 12, further comprising:
determining, by the controller, that the fuel cell stack is not in the dry state; and
controlling, based on the determining that the fuel cell stack is not in the dry state, the opening and closing door to move to a position configured to open the portion of the discharge line and close the bypass line.

16. A method of controlling a water trap apparatus of a fuel cell stack, the method comprising:
determining, by a controller of the water trap apparatus, whether the fuel cell stack is in a dry state; and
controlling, by the controller via a control current, a first electromagnet and a second electromagnet mounted on a water trap to form a first magnetic field, wherein the controlling of the first electromagnet and the second electromagnet comprises:
based on the fuel cell stack being in the dry state, causing the control current to be a first control current configured to cause the first electromagnet and the second electromagnet to form the first magnetic field in a first direction such that the first magnetic field applies a force on water molecules to guide the water molecules to a recirculation outlet of the water trap; or
based on the fuel cell stack not being in the dry state, causing the control current to be a second control current configured to cause the first electromagnet and the second electromagnet to form the first magnetic field in a second direction such that the first magnetic field applies a force on water molecules to guide the water molecules to a first portion, of an inside of the water trap, separated from the recirculation outlet, and
wherein a third magnet and a fourth magnet mounted on the water trap form a second magnetic field in a direction such that the second magnetic field applies a force on oxygen molecules to guide the oxygen molecules to the first portion of the inside of the water trap.

17. The method of claim 16, further comprising:
determining whether a voltage deviation between unit cells of the fuel cell stack exceeds a reference value during operation of the fuel cell stack, wherein the determining whether the fuel cell stack is in the dry state comprises:
based on the voltage deviation being less than or equal to the reference value:
determining whether a coolant outlet temperature of the fuel cell stack is higher than a reference temperature;
measuring, based on the coolant outlet temperature of the fuel cell stack being higher than the reference temperature, a high frequency resistance as cell resistance of the fuel cell stack; and
determining, based on the measured high frequency resistance being greater than or equal to a value obtained by multiplying an average value of a plurality of previous high frequency resistances by a deterioration constant, that the fuel cell stack is in the dry state; or
based on the voltage deviation being greater than the reference value:
measuring an anode impedance and an cathode impedance of the fuel cell stack; and
determining, based on the measured anode impedance or cathode impedance being higher than or equal to a value obtained by multiplying an average value of a plurality of previous impedances by a deterioration constant, that the fuel cell stack is in a flooded state.

18. The method of claim 16, further comprising:
determining whether the second control current has been applied for at least a designated period of time from a current start-up time of the fuel cell stack;
determining, based on the second control current having been applied for at least the designated period of time, whether cold shutdown control has been performed at a time of previous shutdown the fuel cell stack; and performing one of:
determining, based on an external temperature being higher than or equal to a high reference temperature and based on the cold shutdown control having been performed, that the fuel cell stack is in the dry state; or
determining, based on an external temperature being lower than or equal to a low reference temperature and based on the cold shutdown control not having been performed, that the fuel cell stack is in a frozen state.

19. The method of claim 16, wherein the third magnet is a third electromagnet and the fourth magnet is a fourth electromagnet, and the method further comprises:
controlling, by the controller and via a third control current, the third electromagnet and the fourth electromagnet to form the second magnetic field.
